(19) United States
(12) Patent Application Publication
(10) Pub. No.: US 2019/0054605 A1
(43) Pub. Date: Feb. 21, 2019

(54) STAPLE GUIDING STRUCTURE

(71) Applicant: APEX MFG. CO., LTD., Taichung City (TW)

(72) Inventor: Chia-Tse CHEN, Taichung City (TW)

(21) Appl. No.: 15/680,717

(22) Filed: Aug. 18, 2017

(51) Int. Cl. B25C 5/02; B25C 5/16

(52) U.S. Cl. CPC B25C 5/0207; B25C 5/1606; B25C 5/0221

(57) ABSTRACT

A stapler guiding structure is provided, adapted for being disposed on a stapler, the stapler including a main body, the stapler guiding structure including: a magazine assembly, configured to be disposed on the main body and configured to receive a staple unit, including a staple outlet and a stopper member close to the staple outlet, the staple outlet being configured for a staple of the staple unit to pass therethrough; a grooved unit, configured to be disposed on the main body and facing the staple outlet, including at least one groove, each groove including a guiding surface which extends along a guiding path, the guiding surface being configured to bend a leg of the staple which passes through the staple outlet, the guiding path being directed toward the stopper member.

### BACKGROUND OF THE INVENTION

### Field of the Invention

The present invention relates to a staple guiding structure.

### Description of the Prior Art

The stapler is usually used in document processing to combine papers or objects. To ensure that papers or objects are not easy to separate, the stapler is provided with a grooved unit to bend the legs which penetrate the papers or objects to pierce back into the papers or objects so that the papers or objects are fixedly combined. TWI371353, TWM454295 and TWM503324 disclose the like structure.

However, the conventional stapler cannot control bending level of the legs of the staple exactly, due to assembly error of the grooved unit and staple outlet, manufacturing error of the grooved unit, deformation of the grooved unit after use, long legs or thin objects, for example, so that the legs which are bent back can pierce the papers or objects, thus causing injury and having a bad and unflat appearance.

The present invention is, therefore, arisen to obviate or at least mitigate the above mentioned disadvantages.

### SUMMARY OF THE INVENTION

The main object of the present invention is to provide a staple guiding structure which can avoid penetration of legs of a staple from object.

To achieve the above and other objects, a staple guiding structure is provided, adapted for being disposed on a stapler, the stapler including a main body, the stapler guiding structure including: a magazine assembly, configured to be disposed on the main body and configured to receive a staple unit, including a staple outlet and a stopper member close to the staple outlet, the staple outlet being configured for a staple of the staple unit to pass therethrough; a grooved unit, configured to be disposed on the main body and facing the staple outlet, including at least one groove, each groove including a guiding surface which extends along a guiding path, the guiding surface being configured to bend a leg of the staple which passes through the staple outlet, the guiding path being directed toward the stopper member.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a partial breakdown view of a preferred embodiment of the present invention;

FIGS. 3 and 4 are stereograms showing a grooved unit of a preferred embodiment of the present invention;

FIGS. 5 and 6 are side views showing a stapler having a stapler guiding structure in use according a preferred embodiment of the present invention;

FIGS. 7 and 8 are partial side views showing a stapler having a stapler guiding structure in use according a preferred embodiment of the present invention; and

FIG. 9 is a view taken in another angle of view from FIG. 8.

### DETAILED DESCRIPTION OF THE PREFERRED EMBODIMENTS

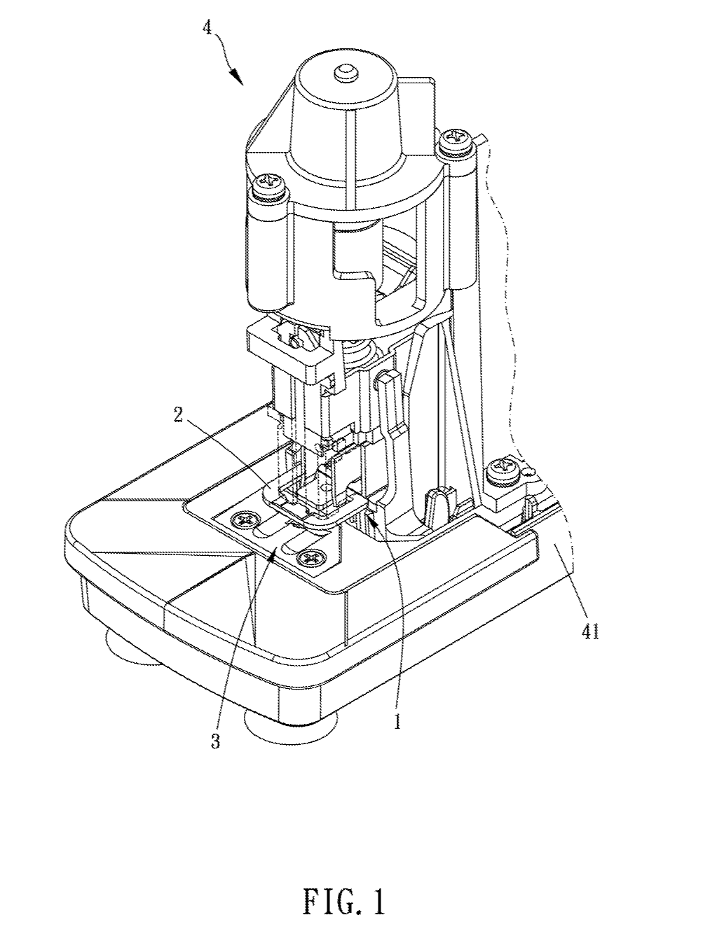

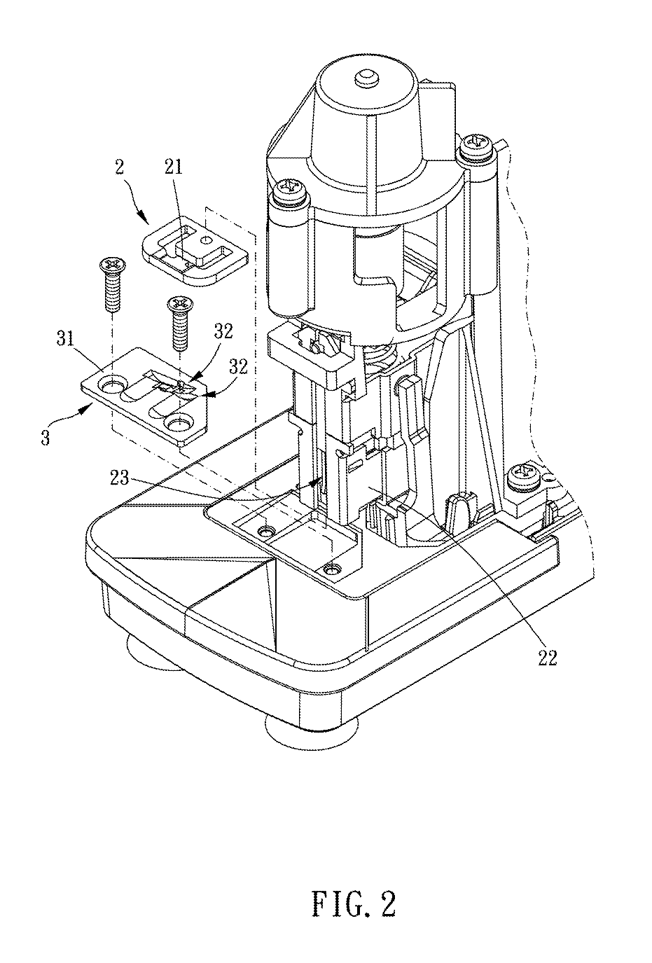

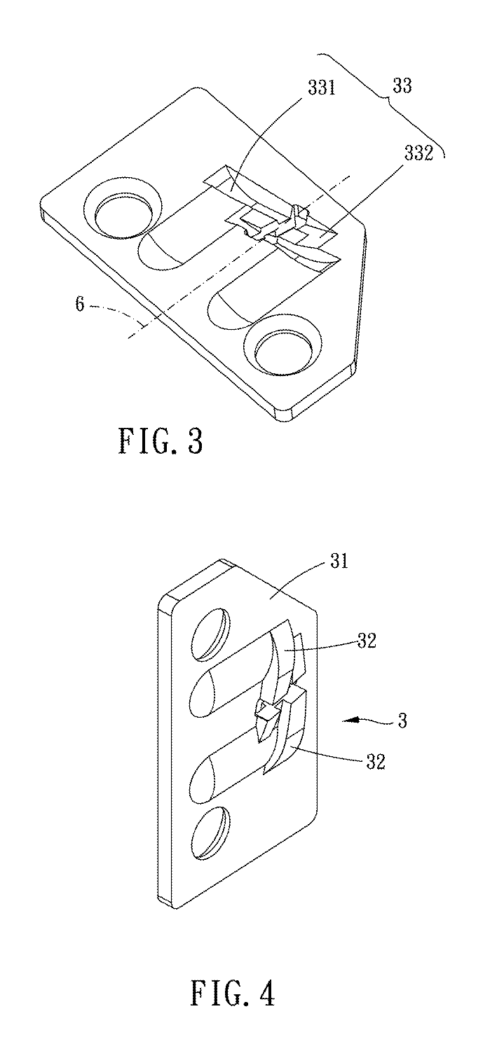

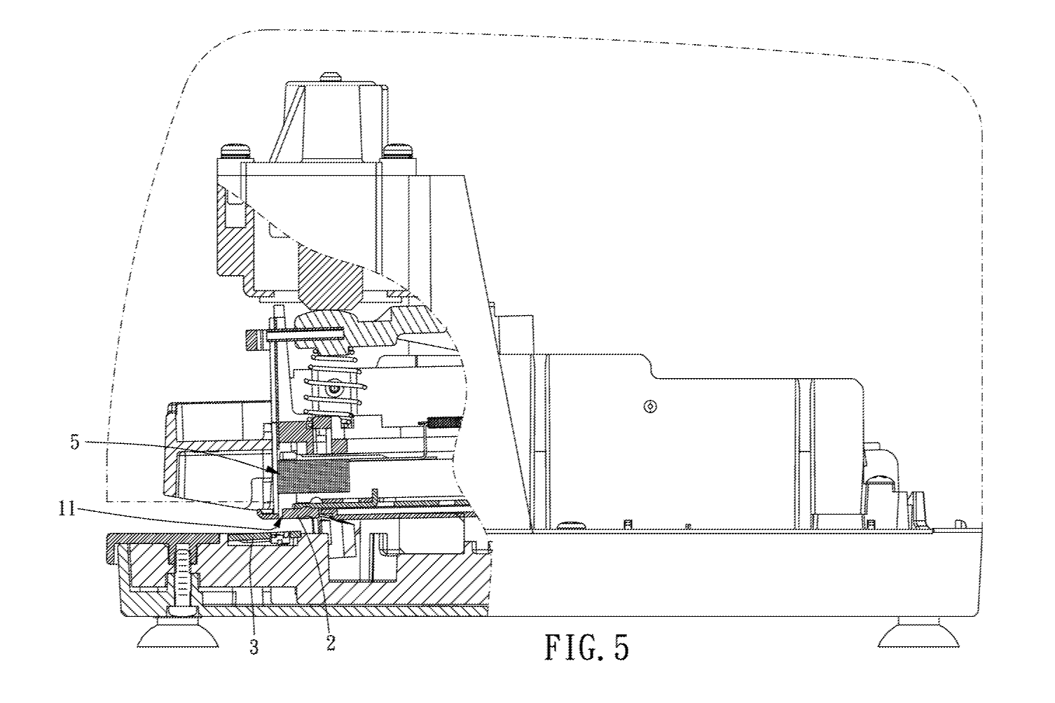

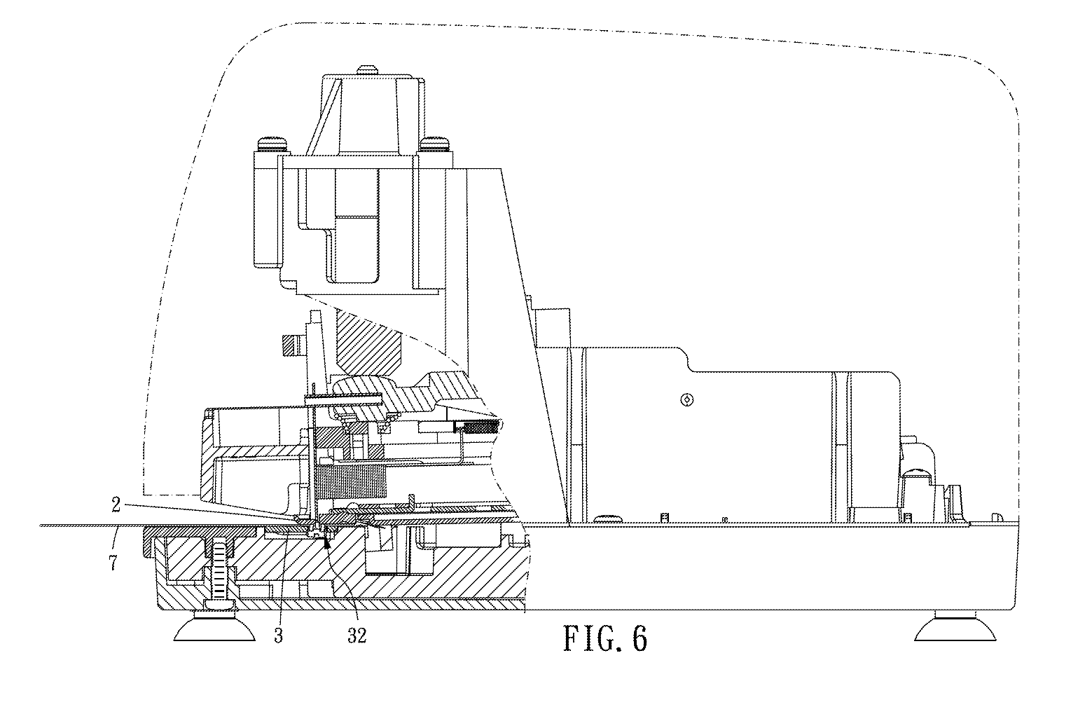

Please refer to FIG. 1 to FIG. 9 show a staple guiding structure according to a preferred embodiment of the present invention. The stapler guiding structure is adapted for being disposed on a stapler 4 which includes a main body 41. The staple guiding structure includes a magazine assembly 1 and a grooved unit 3.

The magazine assembly 1 is configured to be disposed on the main body 41 and configured to receive a staple unit 5. The magazine assembly 1 includes a staple outlet 11 and a stopper member 2 close to the staple outlet 11, and the staple outlet 11 is configured for a staple 51 of the staple unit 5 to pass therethrough. The grooved unit 3 is configured to be disposed on the main body 41 and faces the staple outlet 11. The grooved unit 3 includes at least one groove 32, and each groove 32 includes a guiding surface 33 which extends along a guiding path. The guiding surface 33 is configured to bend a leg 511 of the staple 51 which passes through the staple outlet 11, wherein the guiding path is directed toward the stopper member 2.

In use, an object 7 (such as a stack of paper) is disposed between the magazine assembly 1 and the grooved unit 3; as striking the staple, the magazine assembly 1, the stopper member 2 and the grooved unit 3 clamp the object 7; the stopper member 2 is pressed on a first side 71 of the object 7, and the grooved unit 3 is located at a second side 72 of the object 7. A strike plate 42 of the stapler 4 strikes the staple 51 so that the leg 511 moves from the first side 71 to the second side 72, and the leg 511 is then guided by the guiding surface 33 to bends toward the second side 72 so as to clamp the object 7. Preferably, a side face of the stopper member 2 facing the grooved unit 3 is a plane for abutting stably against the first side 71 in surface contact, thus stabilizing operation of the stapler 4.

Since the guiding path is directed toward the stopper member 2, the stopper member 2 is interferentially located on an extension direction in which the leg 511 that is bent extends. The stopper member 2 on the first side 71 can exactly block the leg 511, thus avoiding penetration of the leg 511 from the first side 71. In other words, the leg 511 is entirely within the object 7 and does not project out from the first side 71, thus avoiding injury due to the leg 511 and having a good and flat appearance.

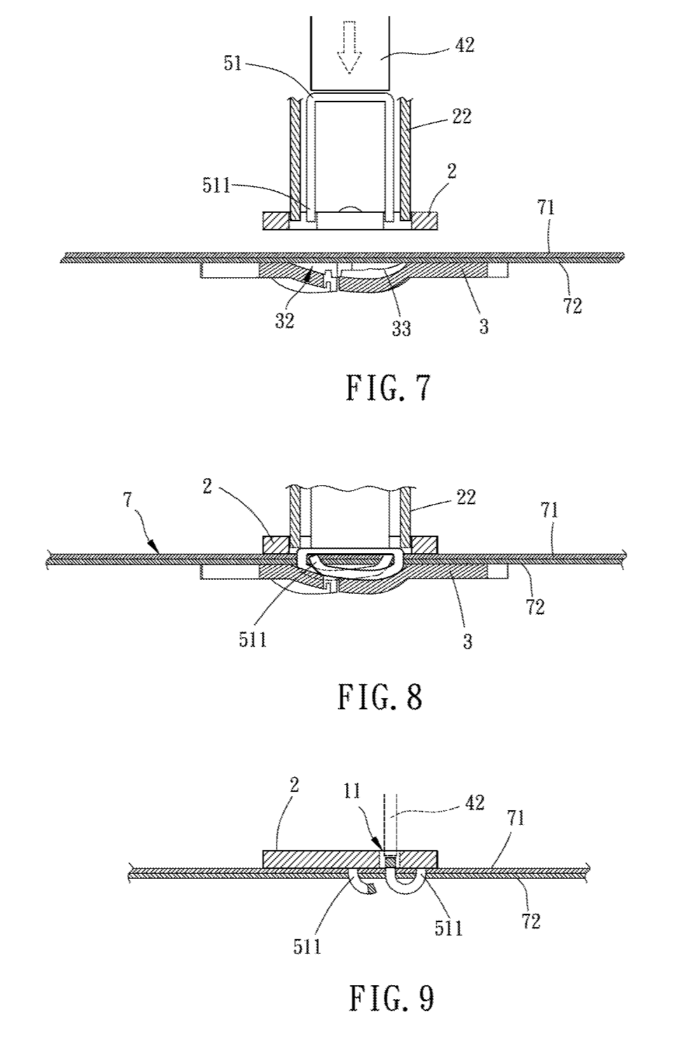

In this embodiment, the staple 51 is a U-shaped staple having two legs 511, and a number of the at least one groove 32 is two. Specifically, the grooves 32 are arranged along a first direction 6, the guiding surfaces 33 of the grooves 32 are transverse to and intercross the first direction 6, and the first direction 6 is perpendicular to an opening direction of the staple outlet 11. The grooved unit 3 can make the legs 511 of the staple 51 shift in their respective bending and leading direction. One of the two legs 511 is bent relatively frontward and toward the staple outlet 11 and the other is bent relatively rearward and toward the staple outlet 11, so that the two legs 511 are abutted against relative front and rear portions of the stopper member 2, respectively (as shown in FIG. 9).

As viewed in a direction perpendicular to the opening direction of the staple outlet 11, the stopper member 2 is larger than the at least one groove 32. When striking, in which the guiding path extends, the stopper member 2 at least covers the at least one groove 32. Specifically, the grooved unit 3 further includes a board 31, each groove 32 is grooved on the board 31, a first end portion 331 of the guiding surface 33 is configured to receive the leg 511, and a second end portion 332 of the guiding surface 33 is configured to guide the leg 511 to project out of and beyond the guiding surface. The first end portion 331 may be not covered by the stopper member 2, while the rest portion of the guiding surface 33 is preferably covered by the stopper member 2, which exactly block the leg 511 regardless of how the leg 511 is bent. Specifically, the first end portion 331 is deeper than the second end portion 332, and the guiding surface 33 is archedly curved, so that the object 7 can be stably fixed.

The magazine assembly 1 further includes a cartridge 22, the staple outlet 11 is disposed on the cartridge 22, and the stopper member 2 is attached to the cartridge 22 and disposed around the staple outlet 11. The stopper member 2 is located correspondingly under the cartridge 22. In other words, the stopper member 2 is disposed between the cartridge 22 and the grooved unit 3. The cartridge 22 includes a slot 23, the slot 23 extends toward the opening direction of the staple outlet 11, and the stopper member 2 includes a positioning member 21 disposed within the slot 23, and thus the stopper member 2 is stable and uneasy to shake.

The stopper member 2 is preferably made of metal so that it has good rigidity for blocking the leg 511 and is durable. Preferably, the stopper member 2 has a thickness equal to or smaller than 5 millimeters for light weight. In this embodiment, the stopper member 2 is substantially rectangular, and each of four corners of the stopper member 2 is rounded. Two of the four corners of the stopper member which are close to the staple outlet are sized larger than the other two of the four corners of the stopper member, which can avoiding obstacle(s) to the stopper member 2 when the stapler moves.

In sum, the staple guiding structure can keep the legs of the staple which are bent to come within the object. In other words, the legs of the staple which are bent cannot project out from the object, thus avoiding injury due to the leg 511 and having a good and flat appearance.

While we have shown and described various embodiments in accordance with the present invention, it should be clear to those skilled in the art that further embodiments may be made without departing from the scope of the present invention.

What is claimed is:

1. A stapler guiding structure, adapted for being disposed on a stapler, the stapler including a main body, the stapler guiding structure including:
a magazine assembly, configured to be disposed on the main body and configured to receive a staple unit, including a staple outlet and a stopper member close to the staple outlet, the staple outlet being configured for a staple of the staple unit to pass therethrough;
a grooved unit, configured to be disposed on the main body and facing the staple outlet, including at least one groove, each groove including a guiding surface which extends along a guiding path, the guiding surface being configured to bend a leg of the staple which passes through the staple outlet, the guiding path being directed toward the stopper member.

2. The staple guiding structure of claim 1, wherein a number of the at least one groove is two, the grooves are arranged along a first direction, the guiding surfaces of the grooves are transverse to and intercross the first direction, and the first direction is perpendicular to an opening direction of the staple outlet.

3. The staple guiding structure of claim 1, wherein the grooved unit further includes a board, each groove is grooved on the board, a first end portion of the guiding surface is configured to receive the leg, a second end portion of the guiding surface is configured to guide the leg to project out of and beyond the guiding surface, and the first end portion is deeper than the second end portion.

4. The staple guiding structure of claim 1, wherein the guiding surface is archedly curved.

5. The staple guiding structure of claim 1, wherein as viewed in a direction perpendicular to an opening direction of the staple outlet, the stopper member is larger than the at least one groove, and in a direction in which the guiding path extends, the stopper member at least covers the at least one groove.

6. The staple guiding structure of claim 1, wherein a side face of the stopper member facing the grooved unit is a plane.

7. The staple guiding structure of claim 1, wherein the magazine assembly further includes a cartridge, the staple outlet is disposed on the cartridge, and the stopper member is attached to the cartridge and disposed around the staple outlet.

8. The staple guiding structure of claim 7, wherein the cartridge includes a slot, the slot extends toward an opening direction of the staple outlet, and the stopper member includes a positioning member disposed within the slot.

9. The staple guiding structure of claim 7, wherein the stopper member is disposed correspondingly under the cartridge, and the stopper member is disposed between the cartridge and the grooved unit.

10. A stapler including the staple guiding structure of claim 9, wherein a number of the at least one groove is two, the grooves are arranged along a first direction, the guiding surfaces of the grooves are transverse to and intercross the first direction, and the first direction is perpendicular to an opening direction of the staple outlet; the grooved unit further includes a board, each groove is grooved on the board, a first end portion of the guiding surface is configured to receive the leg, a second end portion of the guiding surface is configured to guide the leg to project out of and beyond the guiding surface, and the first end portion is deeper than the second end portion; the guiding surface is archedly curved; as viewed in a direction perpendicular to an opening direction of the staple outlet, the stopper member is larger than the at least one groove, and in a direction in which the guiding path extends, the stopper member at least covers the at least one groove; a side face of the stopper member facing the grooved unit is a plane;
the cartridge includes a slot, the slot extends toward an opening direction of the staple outlet, and the stopper member includes a positioning member disposed within the slot; the stopper member is substantially rectangular, each of four corners of the stopper member is rounded, two of the four corners of the stopper member which are close to the staple outlet are sized larger than the other two of the four corners of the stopper member, and the stopper member is made of metal and has a thickness equal to or smaller than 5 millimeters.
